(19) United States
(12) Patent Application Publication
(10) Pub. No.: US 2025/0167486 A1
(43) Pub. Date: May 22, 2025

(54) CONNECTOR, CONNECTOR ASSEMBLY AND CONNECTOR SEPARATION METHOD

(71) Applicant: SUMITOMO WIRING SYSTEMS, LTD., Mie (JP)

(72) Inventor: Hiroki MATSUYAMA, Mie (JP)

(21) Appl. No.: 18/938,885

(22) Filed: Nov. 6, 2024

(30) Foreign Application Priority Data
Nov. 17, 2023 (JP) 2023-195877

(51) Int. Cl. H01R 13/621; H01R 13/635; H01R 13/6591; H01R 43/26

(52) U.S. Cl. CPC H01R 13/6215; H01R 13/635; H01R 13/6591; H01R 43/26

(57) ABSTRACT

A connector includes a shield shell fixable to a fixing member provided with a mating connector by a stud bolt, and a connector body held inside the shield shell and connectable to the mating connector by an axial force of the stud bolt. The shield shell includes an internally threaded hole threadably engageable with the stud bolt and is fixable to the fixing member by threadably engaging a nut with the stud bolt threadably engaged with the internally threaded hole and passed through a through hole of the fixing member. The connector body is separable from the mating connector by being relatively moved in a separation direction with respect to the mating connector by an axial force of a separation bolt threadably engaged with the internally threaded hole with the stud bolt and the nut removed and with the through hole closed by a closing member.

### CROSS-REFERENCE TO RELATED APPLICATIONS

This application is based on and claims priority from Japanese Patent Application No. 2023-195877, filed on Nov. 17, 2023, with the Japan Patent Office, the disclosure of which is incorporated herein in its entirety by reference.

### TECHNICAL FIELD

The present disclosure relates to a connector, a connector assembly and a connector separation method.

### BACKGROUND

A conventionally known connector assembly is provided with a mating connector, a fixing member fixed to the mating connector, a shield shell to be fixed to the fixing member by a bolt and a connector body to be held inside the shield shell (see, for example, Japanese Patent Laid-open Publication No. 2013-054929). In this connector assembly, the connector body can be connected to the mating connector by an axial force of the bolt threadably engaged with a female screw provided in the fixing member through a through hole provided in the shield shell. Further, since the bolt is made impossible to relatively move with respect to the shield shell by a C-ring, a connector provided with the shield shell and the connector body can be separated from the fixing member by an axial force of the bolt by rotating the bolt in a loosening direction.

### SUMMARY

In the connector assembly as described above, it may be difficult to provide the female screw in the fixing member or a fixing operation of tightening the bolt on the side of the shield shell may be difficult. In such cases, the connector body can be connected to the mating connector, for example, by threadably engaging a nut with the bolt passed through the through holes of the shield shell and the fixing member from the side of the shield shell. However, in this case, the connector body cannot be separated from the mating connector even if the bolt and the nut are loosened. Thus, the connector body needs to be separated from the mating connector, for example, by providing an internally threaded hole dedicated for separation at a position different from the through hole of the fixing member and pushing the shield shell by a separation bolt threadably engaged with that internally threaded hole. However, in this case, a position where the axial force acts differs between during connection and during separation since the through hole and the internally threaded hole are at different positions. Thus, a large twisting force may act on the connector at least either during the connection or during the separation.

The present disclosure aims to provide a connector, a connector assembly and a connector separation method capable of suppressing twisting forces generated during connection and during separation.

The present disclosure is directed to a connector with a shield shell fixable to a fixing member provided with a mating connector by a bolt and a connector body held inside the shield shell, the connector body being connectable to the mating connector by being relatively moved in a connection direction along a first axis with respect to the mating connector by an axial force of the bolt, the shield shell including an internally threaded hole threadably engageable with the bolt, the shield shell being fixable to the fixing member by threadably engaging a nut with the bolt threadably engaged with the internally threaded hole and passed through a through hole of the fixing member, and the connector body being separable from the mating connector by being relatively moved in a separation direction along the first axis with respect to the mating connector by an axial force of a separation bolt threadably engaged with the internally threaded hole with the bolt and the nut removed and with the through hole closed by a closing member.

According to a connector, a connector assembly and a connector separation method of the present disclosure, twisting forces generated during connection and during separation can be suppressed.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view of a connector assembly in one embodiment.

FIG. 2 is a perspective view of the connector assembly in the embodiment.

FIG. 3 is a perspective view showing an assembly method of the connector assembly in the embodiment.

FIG. 4 is a perspective view showing the assembly method of the connector assembly in the embodiment.

FIG. 5 is a perspective view showing a state before a closing member is mounted in a connector separation method in the embodiment.

FIG. 6 is a perspective view showing a state before the closing member is separated by a separation bolt after being mounted in the connector separation method in the embodiment.

FIG. 7 is a section showing a first half of the connector separation method in the embodiment.

FIG. 8 is a section showing a second half of the connector separation method in the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF PRESENT DISCLOSURE

Embodiments of the present disclosure are first listed and described.

[1] The connector of the present disclosure is provided with a shield shell fixable to a fixing member provided with a mating connector by a bolt and a connector body held inside the shield shell, the connector body being connectable to the mating connector by being relatively moved in a connection direction along a first axis with respect to the mating connector by an axial force of the bolt, the shield shell including an internally threaded hole threadably engageable with the bolt, the shield shell being fixable to the fixing member by threadably engaging a nut with the bolt threadably engaged with the internally threaded hole and passed through a through hole of the fixing member, and the connector body being separable from the mating connector by being relatively moved in a separation direction along the first axis with respect to the mating connector by an axial force of a separation bolt threadably engaged with the internally threaded hole with the bolt and the nut removed and with the through hole closed by a closing member.

According to this configuration, since the shield shell includes the internally threaded hole threadably engageable with the bolt, the bolt can be fixed without using a C-ring. Thus, for example, even when it is difficult to provide a female screw in the fixing member or when a fixing operation at the side of the shield shell is difficult, the shield shell can be fixed to the fixing member by threadably engaging the nut with the bolt passed through the through hole. Further, since the connector body can be separated from the mating connector by an axial force of the separation bolt threadably engaged with the internally threaded hole with the through hole closed by the closing member, the action of a twisting force on the connector can be maximally prevented during connection and during separation. That is, positions where the axial force acts during connection and during separation can be set at the same position (same axis) where a twisting force least acts on the connector.

[2] In [1] described above, the shield shell may include a tubular shell body for accommodating the connector body and an extending portion projecting from the shell body in a direction orthogonal to the first axis and provided with the internally threaded hole, and the internally threaded hole may be so provided that a through axis thereof coincides with a center of the shell body when viewed from a projecting direction of the extending portion.

According to this configuration, since the internally threaded hole is so provided that the through axis thereof coincides with the center of the shell body when viewed from the projecting direction of the extending portion, the action of a twisting force on the connector can be maximally prevented during connection and during separation.

[3]A connector assembly of the present disclosure may be provided with the connector of [1] or [2] described above, the mating connector, the fixing member, the bolt and the nut, the bolt being a stud bolt.

According to this configuration, since the bolt is the stud bolt, a screw thread of a part to be threadably engaged with the nut can be kept new until the nut is threadably engaged. That is, for example, if the bolt is a normal headed bolt provided with a head part, a part to be threadably engaged with the nut later also needs to be passed through the internally threaded hole. Thus, the screw thread of the part to be threadably engaged with the nut may be deteriorated. However, this problem can be avoided. Therefore, the nut can be stably threadably engaged and the shield shell can be stably fixed to the fixing member.

[4] In [3] described above, a locking nut may be provided which prevents loosening of the stud bolt with respect to the internally threaded hole by being threadably engaged with a part of the stud bolt projecting from the internally threaded hole.

According to this configuration, since the locking nut is provided which prevents the loosening of the stud bolt with respect to the internally threaded hole by being threadably engaged with the part of the stud bolt projecting from the internally threaded hole, the loosening of the stud bolt with respect to the internally threaded hole is prevented. Thus, the shield shell can be more stably fixed to the fixing member.

[5]A connector separation method of the present disclosure is a separation method of the connector of [1] or [2] described above fixed to the fixing member and provided with an untightening step of releasing a tightened state by removing the nut and the bolt, a closing step of closing the through hole by the closing member, and a separating step of separating the connector body from the mating connector by relatively moving the connector body in the separation direction with respect to the mating connector by an axial force generated in threadably engaging the separation bolt with the internally threaded hole.

According to this method, the tightened state is released by removing the nut and the bolt in the untightening step. In the closing step, the through hole of the fixing member is closed by the closing member. In the separating step, the connector body is separated from the mating connector by being relatively moved in the separation direction with respect to the mating connector by an axial force generated in threadably engaging the separation bolt with the internally threaded hole. Note that, at this time, the axial force is generated by the separation bolt butting against the closing member. By doing so, the action of a twisting force on the connector can be maximally prevented during connection and during separation. That is, positions where the axial direction acts during connection and during separation can be set at the same position (same axis) where a twisting force least acts on the connector.

### DETAILS OF EMBODIMENT OF PRESENT DISCLOSURE

A specific example of a connector assembly of the present disclosure is described below with reference to the drawings. For the convenience of description, some components may be shown in an exaggerated or simplified manner in each drawing. Further, a dimension ratio of each part may be different in each drawing. “Parallel”, “orthogonal” and “true circular” in this specification mean not only strictly parallel, orthogonal and true circular, but also substantially parallel, orthogonal and true circular within a range in which functions and effects in this embodiment are achieved. Note that the present invention is not limited to these illustrations, but is represented by claims and intended to include all changes in the scope of claims and in the meaning and scope of equivalents.

### (Configuration of Connector Assembly 11)

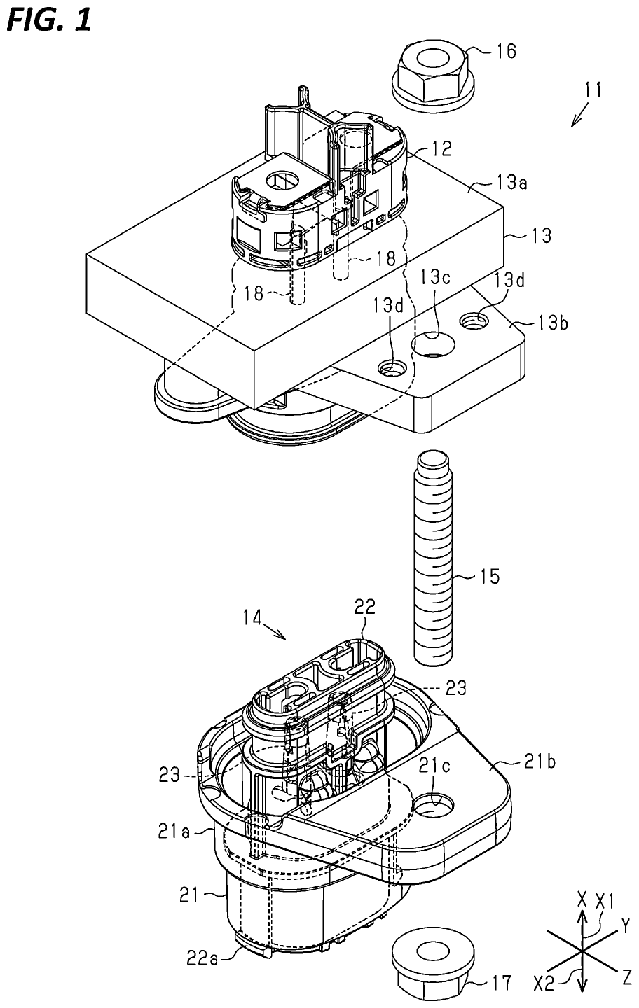

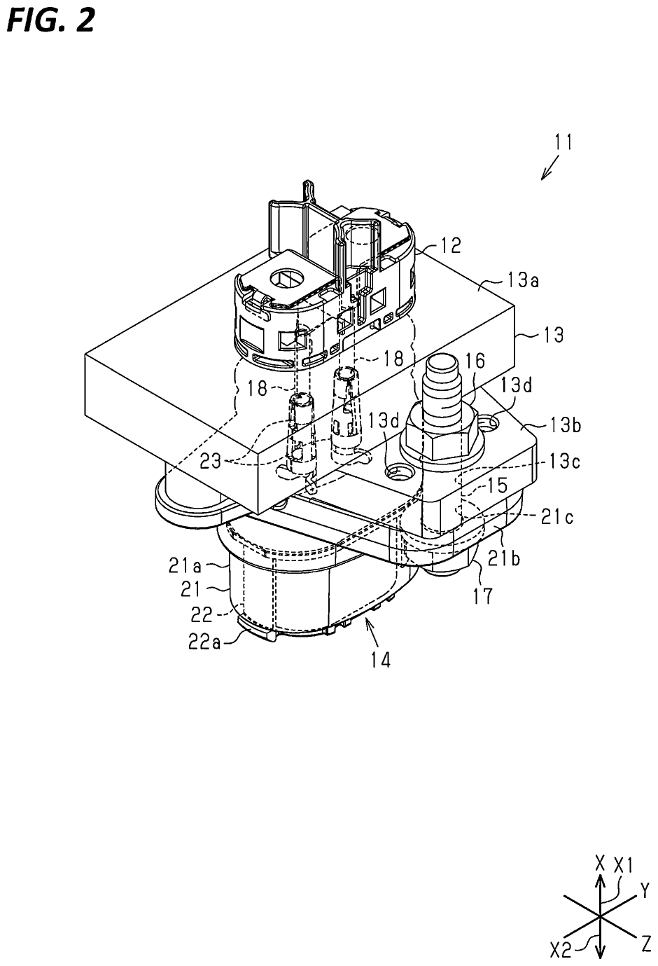

As shown in FIGS. 1 and 2, a connector assembly 11 is provided with a mating connector 12, a fixing member 13, a connector 14, a stud bolt 15 as a bolt, a nut 16 and a locking unit 17. The connector assembly 11 is provided in a vehicle. Note that a first axis X, a second axis Y orthogonal to the first axis X and a third axis Z orthogonal to the first axis X and the second axis Y are shown in figures. Further, a connection direction X1, which is one direction along the first axis X, and a separation direction X2, which is the other direction along the first axis X and opposite to the connection direction X1, are shown in the figures.

### (Configurations of Mating Connector 12 and Fixing Member 13)

The mating connector 12 is provided on the fixing member 13. The fixing member 13 is, for example, a case of a device provided in the vehicle or the like. The fixing member 13 is made of a metal material. The fixing member 13 includes a holding portion 13a for holding the mating connector 12 and a fixing portion 13b projecting from the holding portion 13a. The fixing portion 13b includes a through hole 13c penetrating along the first axis X. Further, the fixing portion 13b includes two internally threaded portions 13d recessed along the first axis X on both sides of the through hole 13c. The mating connector 12 is made of a resin material. The mating connector 12 is formed into a tubular shape and holds two mating terminals 18 inside. Core wires of unillustrated wires are connected to the mating terminals 18. Note that each of the two mating terminals 18 extends along the first axis X. Further, the two mating terminals 18 are provided side by side along the second axis Y Further, a width of the mating connector 12 along the second axis Y, in which the two mating terminals 18 are arranged, is set to be larger than a depth of the mating connector 12 along the third axis Z.

### (Configuration of Connector 14)

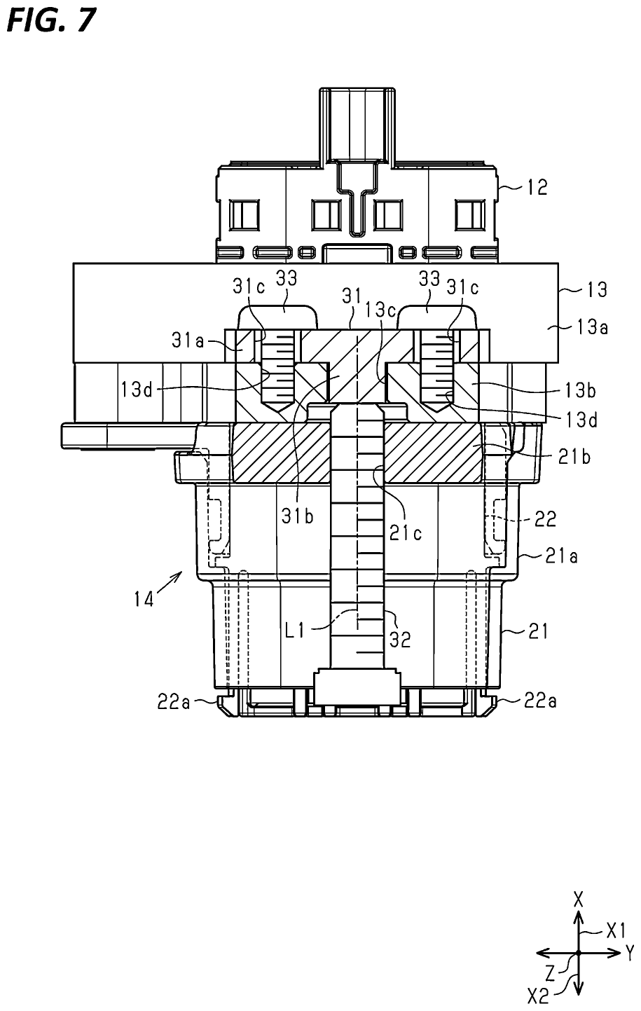

The connector 14 is provided with a shield shell 21 and a connector body 22. The shield shell 21 is made of a metal material. The shield shell 21 includes a tubular shell body 21a for accommodating and holding the connector body 22 and an extending portion 21b projecting from the shield shell 21a in a direction, which is orthogonal to the first axis X and the same direction as a projecting direction of the fixing portion 13b. The extending portion 21b includes an internally threaded hole 21c penetrating along the first axis X. The internally threaded hole 21c is so provided that a through axis L1 (see FIG. 7) thereof coincides with a center of the shield shell 21a when viewed from the projecting direction of the extending portion 21b.

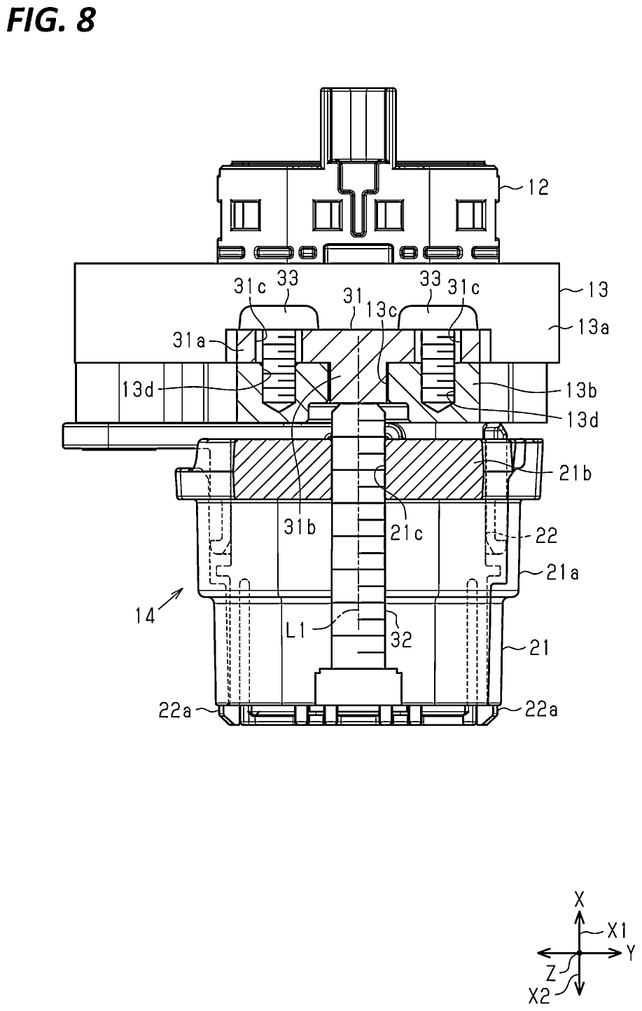

The connector body 22 is made of a resin material. The connector body 22 is formed into a tubular shape and holds two connector terminals 23 inside. Core wires of unillustrated wires are connected to the connector terminals 23. Note that each of the two connector terminals 23 extends along the first axis X. Further, the two connector terminals 23 are provided side by side along the second axis Y Further, a width of the connector body 22 along the second axis Y, in which the two connector terminals 23 are arranged, is set to be larger than a depth of the connector body 22 along the third axis Z. Further, in this embodiment, the connector body 22 includes a pair of claws 22a (see FIGS. 7 and 8) on both sides when viewed from the projecting direction of the extending portion 21b, and is engaged with the shield shell 21 by the pair of claws 22a.

The shield shell 21 is fixed to the fixing member 13 by threadably engaging the nut 16 with the stud bolt 15 threadably engaged with the internally threaded hole 21c and passed through the through hole 13c of the fixing member 13.

Further, the connector body 22 is connected to the mating connector 12 by being relatively moved in the connection direction X1 along the first axis X with respect to the mating connector 12 by an axial force of the stud bolt 15. Note that the axial force is a force in an axial direction generated when the stud bolt 15 is threadably engaged and, here, means a force in the axial direction generated when the nut 16 is threadably engaged with the stud bolt 15 fixed to the fixing member 13.

Further, the locking nut 17 prevents the loosening of the stud bolt 15 with respect to the internally threaded hole 21c by being threadably engaged with a part of the stud bolt 15 projecting from the internally threaded hole 21c in advance.

Further, the mating terminals 18 of the mating connector 12 and the connector terminals 23 of the connector body 22 are electrically connected by being simultaneously fit when the mating connector 12 and the connector body 22 are connected.

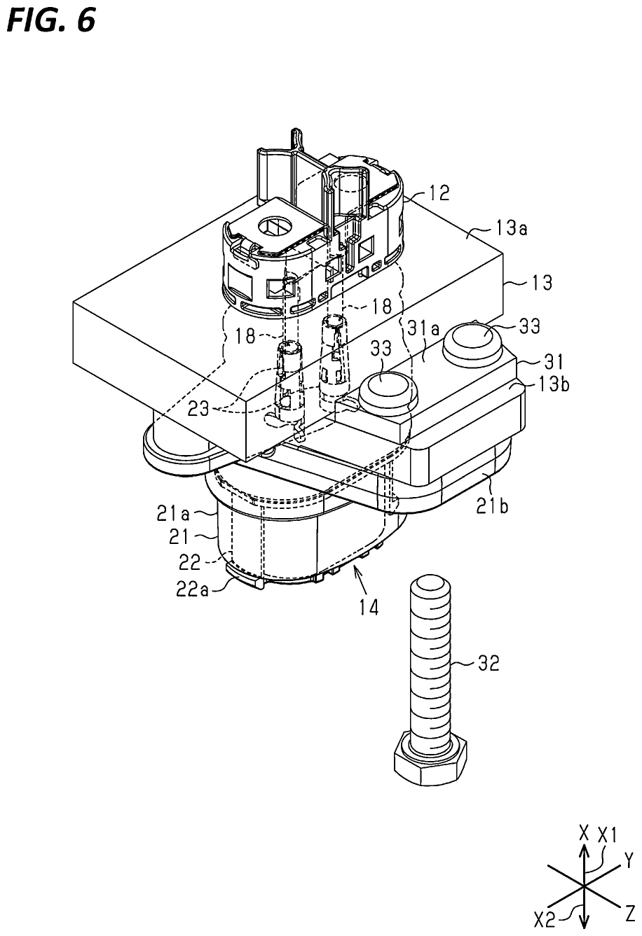

The connector body 22 can be separated from the mating connector 12 with the stud bolt 15, the nut 16 and the locking nut 17 removed and with the through hole 13c of the fixing member 13 closed by a closing member 31 (see FIG. 6). The connector body 22 can be separated from the mating connector 12 by being relatively moved in the separation direction X2 along the first axis X with respect to the mating connector 12 by an axial force of the separation bolt 32 threadably engaged with the internally threaded hole 21c (see FIGS. 7 and 8). That is, the connector body 22 can be separated from the mating connector 12 by an axial force of the separation bolt 32 threadably engaged with the internally threaded hole 21c for pushing the closing member 31. Note that the closing member 31 of this embodiment includes a plate portion 31a to be fixed to the fixing portion 13b and a projecting portion 31b projecting from the plate portion 31a to fill the through hole 13c. The closing member 31 includes fixing holes 31c in the plate portion 31a, and is fixed to the fixing portion 13b by fixing screws 33 threadably engaged with the internally threaded portions 13d of the fixing portion 13b through the fixing holes 31c.

### (Assembly Method of Connector Assembly 11)

Next, an assembly method of the connector assembly 11 configured as described above is described. The assembly method of the connector assembly 11 includes a “bolt fixing step” and a “nut tightening step”.

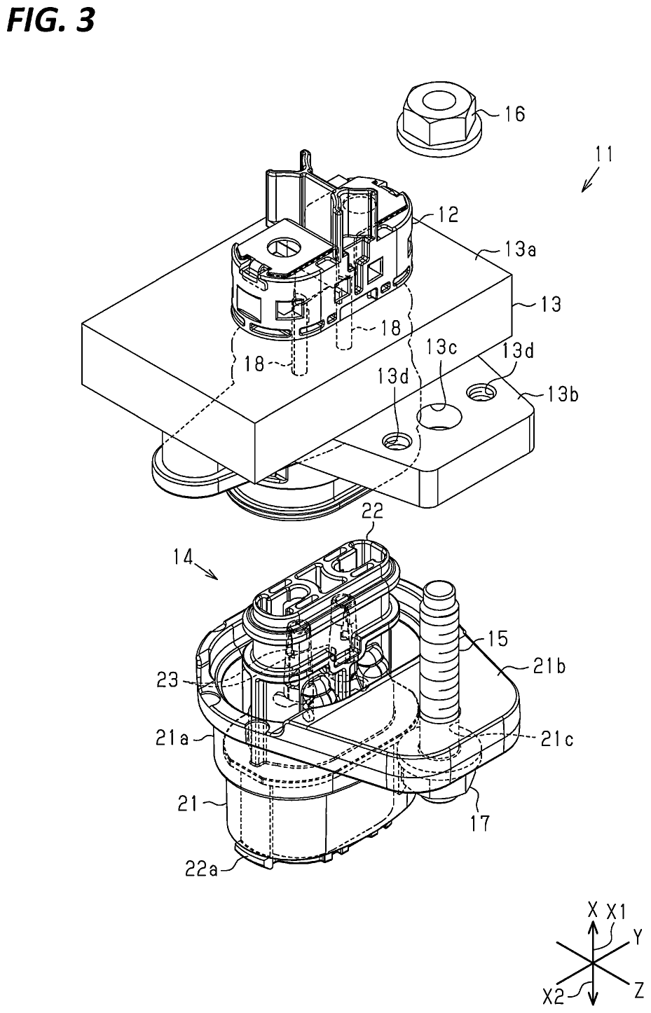

As shown in FIG. 3, in the bolt fixing step, the stud bolt 15 is fixed to the shield shell 21. In the bolt fixing step of this embodiment, the stud bolt 15 is fixed to the shield shell 21 by threadably engaging the stud bolt 15 with the internally threaded hole 21c with an end part in the separation direction X2 (lower end part in FIG. 3) in the lead. Further, in the bolt fixing step of this embodiment, the loosening of the substantially 15 with respect to the internally threaded hole 21c is prevented by threadably engaging the locking nut 17 with the part of the stud bolt 15 projecting from the internally threaded hole 21c.

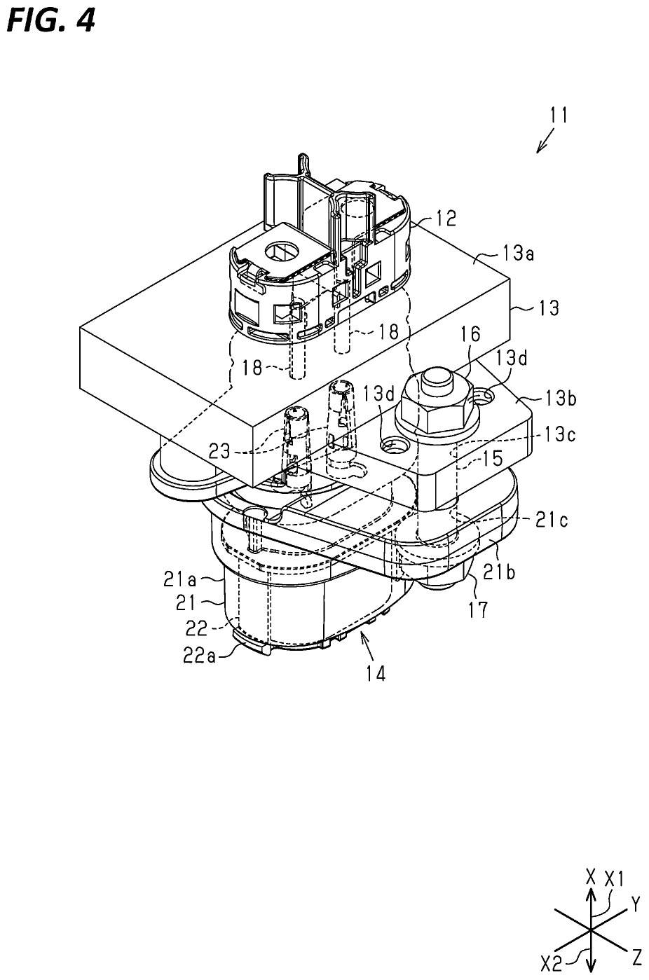

Subsequently, as shown in FIG. 4, the shield shell 21 is fixed to the fixing member 13 by threadably engaging the nut 16 with the stud bolt 15 passed through the through hole 13c of the fixing member 13 in the nut tightening step. At this time, the connector body 22 is connected to the mating connector 12 by being relatively moved in the connection direction X1 along the first axis X with respect to the mating connector 12 by an axial force of the stud bolt 15 together with the shield shell 21. In this way, the connector assembly 11 is assembled as shown in FIG. 2. Note that a rotation direction of the nut 16 in threadably engaging the stud bolt 15 with the nut 16 in the nut tightening step is the same as a rotation direction of the stud bolt 15 in threadably engaging the stud bolt 15 with the internally threaded hole 21c in the bolt fixing step. Thus, the stud bolt 15 is not loosened from the internally threaded hole 21c in threadably engaging the stud bolt 15 with the nut 16 in the nut tightening step.

### (Separation Method of Connector 14)

Next, a separation method of the connector 14 in the connector assembly 11 configured as described above is described. The separation method of the connector 14 includes an “untightening step”, a “through hole closing step” and a “separating step”.

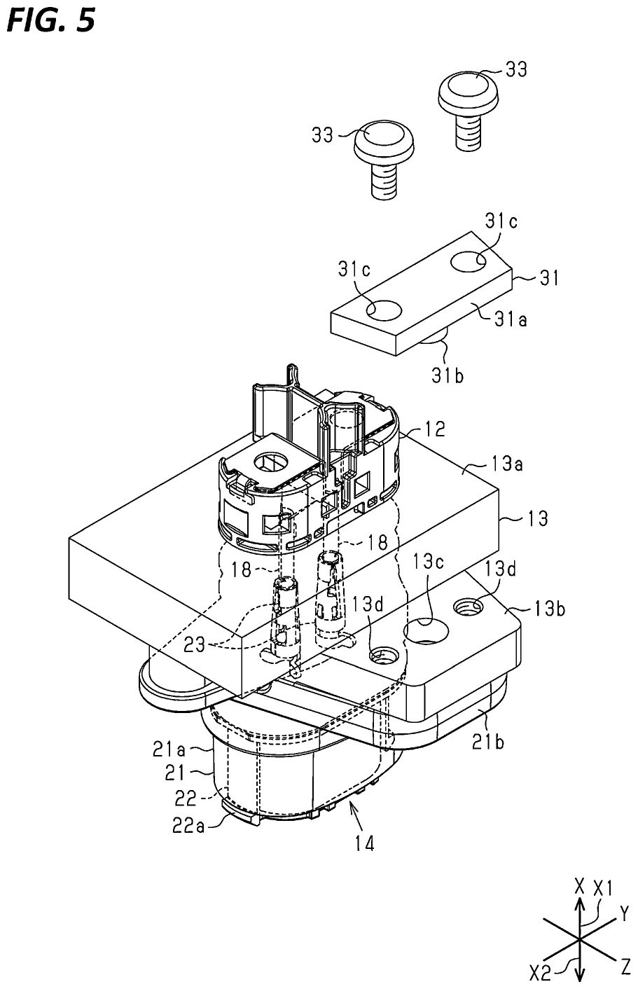

As shown in FIG. 5, in the untightening step, a tightened state is released by first removing the nut 16, the locking nut 17 and the stud bolt 15 from a state shown in FIG. 2. Note that, in the connector assembly 11 of this embodiment, the connector 14 is not separated due to a connection force of the mating connector 12 and the connector body 22 even if the tightened state is released.

Subsequently, as shown in FIG. 6, the through hole 13c of the fixing member 13 is closed by the closing member 31 in the through hole closing step. Specifically, in this embodiment, the plate portion 31a is fixed to the fixing portion 13b by the fixing screws 33 with the projecting portion 31b (see FIG. 5) of the closing member 31 inserted in the through hole 13c.

Subsequently, as shown in FIGS. 7 and 8, the connector body 22 is separated from the mating connector 12 by being relatively moved in the separation direction X2 with respect to the mating connector 12 by an axial force generated in threadably engaging the separation bolt 32 with the internally threaded hole 21c in the separating step. At this time, the connector body 22 is relatively moved from the mating connector 12 fixed to the fixing member 13 together with the shield shell 21 by relatively moving the shield shell 21 in the separation direction X2 with respect to the fixing member 13. In this way, the connector 14 is separated from the mating connector 12 and the fixing member 13.

Next, effects of the above embodiment are described below.

(1) Since the shield shell 21 includes the internally threaded hole 21c threadably engageable with the stud bolt 15, the stud bolt 15 can be fixed without using a C-ring. Thus, for example, even when it is difficult to provide a female screw in the fixing member 13 or when a fixing operation at the side of the shield shell 21 is difficult, the shield shell 21 can be fixed to the fixing member 13 by threadably engaging the nut 16 with the stud bolt 15 passed through the through hole 13c. Further, the connector body 22 can be separated from the mating connector 12 by an axial force of the separation bolt 32 threadably engaged with the internally threaded hole 21c with the through hole 13c closed by the closing member 31. Thus, the action of a twisting force on the connector 14 can be maximally prevented during connection and during separation. That is, positions where the axial force acts during connection and during separation can be set at the same position (same axis) where a twisting force least acts on the connector 14.

(2) Since the internally threaded hole 21c is so provided that the through axis L1 thereof coincides with the center of the shell body 21a when viewed from the projecting direction of the extending portion 21b, the action of a twisting force on the connector 14 can be maximally prevented during connection and during separation. Specifically, in this embodiment, the concentration of a force on one claw 22a during the separation of the connector 14 can be prevented as shown in FIGS. 7 and 8 and, consequently, the breakage of the claw 22a can be suppressed.

(3) Since the bolt is the stud bolt 15, a screw thread of a part to be threadably engaged with the nut 16 can be kept new until the nut 16 is threadably engaged. That is, for example, if the bolt is a normal headed bolt provided with a head part, a part to be threadably engaged with the nut 16 later also needs to be passed through the internally threaded hole 21c. Thus, the screw thread of the part to be threadably engaged with the nut 16 may be deteriorated. However, this problem can be avoided. Therefore, the nut 16 can be stably threadably engaged and the shield shell 21 can be stably fixed to the fixing member 13.

(4) Since the locking nut 17 is provided which prevents the loosening of the stud bolt 15 with respect to the internally threaded hole 21c by being threadably engaged with the part of the stud bolt 15 projecting from the internally threaded hole 21c, the loosening of the stud bolt 15 with respect to the internally threaded hole 21c is prevented. Thus, the shield shell 21 can be more stably fixed to the fixing member 13.

(5) According to the separation method of the connector 14, the tightened state is released by removing the nut 16, the locking nut 17 and the stud bolt 15 in the untightening step. In the closing step, the through hole 13c of the fixing member 13 is closed by the closing member 31. In the separating step, the connector body 22 is separated from the mating connector 12 by being relatively moved in the separation direction X2 with respect to the mating connector 12 by an axial force generated in threadably engaging the separation bolt 32 with the internally threaded hole 21c. Note that, at this time, the axial force is generated by the separation bolt 32 butting against the closing member 31. By doing so, the action of a twisting force on the connector 14 can be maximally prevented during connection and during separation. That is, positions where the axial direction acts during connection and during separation can be set at the same position (same axis) where a twisting force least acts on the connector 14.

The above embodiment can be modified and carried out as follows. The above embodiment and the following modifications can be carried out in combination without technically contradicting each other.
Although the internally threaded hole 21c is so provided that the through axis L1 thereof coincides with the center of the shell body 21a when viewed from the projecting direction of the extending portion 21b in the above embodiment, the position thereof may be changed to another position where a twisting force hardly acts on the connector 14 during connection and during separation. For example, the shapes of the shield shell 21 and the connector body 22 may be changed. Such as when the shapes of the shield shell 21 and the connector body 22 are different from those of the above embodiment, the internally threaded hole 21c may be provided at a position where a twisting force least acts on a weak rigidity part during connection and during separation.
Although the bolt is the stud bolt 15 in the above embodiment, there is no limitation to this and the bolt may be, for example, changed to a headed bolt. Note that, in this case, the locking nut 17 is unnecessary.
Although the locking nut 17 is provided which prevents the loosening of the stud bolt 15 with respect to the internally threaded hole 21c in the above embodiment, there is no limitation to this and the locking nut 17 may not be provided.
Although the mating connector 12 holds two mating terminals 18 and the connector body 22 holds two connector terminals 23 in the above embodiment, there is no limitation to this and, for example, three or more mating terminals 18 and three or more connector terminals 23 may be held.
Although the closing member 31 is fixed to the fixing portion 13b by the two fixing screws 33 in the above embodiment, there is no limitation to this and the closing member 31 may be fixed to the fixing portion 13b by another fixing structure.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a shield shell fixable to a fixing member provided with a mating connector by a bolt; and
a connector body held inside the shield shell, the connector body being connectable to the mating connector by being relatively moved in a connection direction along a first axis with respect to the mating connector by an axial force of the bolt,
the shield shell including an internally threaded hole threadably engageable with the bolt, the shield shell being fixable to the fixing member by threadably engaging a nut with the bolt threadably engaged with the internally threaded hole and passed through a through hole of the fixing member, and
the connector body being separable from the mating connector by being relatively moved in a separation direction along the first axis with respect to the mating connector by an axial force of a separation bolt threadably engaged with the internally threaded hole with the bolt and the nut removed and with the through hole closed by a closing member.

2. The connector of claim 1, wherein:
the shield shell includes a tubular shell body for accommodating the connector body and an extending portion projecting from the shell body in a direction orthogonal to the first axis and provided with the internally threaded hole, and
the internally threaded hole is so provided that a through axis thereof coincides with a center of the shell body when viewed from a projecting direction of the extending portion.

3. A connector assembly, comprising the connector of claim 1, the mating connector, the fixing member, the bolt and the nut,
the bolt being a stud bolt.

4. The connector assembly of claim 3, comprising a locking nut for preventing loosening of the stud bolt with respect to the internally threaded hole by being threadably engaged with a part of the stud bolt projecting from the internally threaded hole.

5. A separation method of the connector of claim 1 fixed to the fixing member, comprising:
an untightening step of releasing a tightened state by removing the nut and the bolt;
a closing step of closing the through hole by the closing member; and
a separating step of separating the connector body from the mating connector by relatively moving the connector body in the separation direction with respect to the mating connector by an axial force generated in threadably engaging the separation bolt with the internally threaded hole.
